(19) United States
(12) Patent Application Publication
(10) Pub. No.: US 2026/0222009 A1
(43) Pub. Date: Jul. 30, 2026

(54) POWER SUPPLY AND ANTENNA ENHANCEMENT FOR NFC DEVICES

(71) Applicant: George Ho Kwong, Huntington Beach, CA (US)

(72) Inventor: George Ho Kwong, Huntington Beach, CA (US)

(21) Appl. No.: 19/038,573

(22) Filed: Jan. 27, 2025

(51) Int. Cl. H04B 5/43; H04B 1/3827; H04B 1/40

(52) U.S. Cl. CPC H04B 5/43; H04B 1/40; H04B 1/385

(57) ABSTRACT

The present invention concerns a power supply arrangement for a portable electronic device. The inventive arrangement uses a large value capacitor in the power supply circuitry to extend the operational life of the battery. The large capacitor builds up the power reserve thereby increasing current output. Because of the small footprint of the device, multiple smaller capacitors are connected in series to build up the large capacitor value. The arrangement preserves battery power by reducing the leakage typically present when using a single large capacitor. The arrangement also effectively reduces the battery's internal resistance.

### BACKGROUND OF THE INVENTION

The present invention relates to electronic circuits. More particularly, it is directed to a improved power supplies and antennas for wearable electronic devices.

NFC, which is short for near-field communication, is a technology that allows devices like phones and smart watches to exchange small bits of data with other devices and read NFC-equipped cards over relatively short distances. The technology behind NFC is very similar to radio-frequency identification (RAID) commonly used in the security cards and chaconne fobs that you likely already use to get into your office or gym.

Wearable and portable devices such as smartphones, watches, and various wearable medical devices typically use NFC technology. A problem with wearable medical devices using NFC technology is battery life. Because the devices are generally small, with some about only an inch square with a thickness of less than an inch, small batteries such as button batteries are required. These batteries are fine for short term use but cannot be relied upon for long periods without charging or replacement.

Since the NFC reading and writing operation requires high power consumption, a typical button battery dies in short period of time. The button battery by nature has limited electrical current, but the NFC operation requires high current to maintain normal operation. The battery can be drained or damaged quickly due to the sudden high current demands by the NFC operation. The battery will stop working altogether when the power capacity depleted below 60% of the battery capacity.

Accordingly, there is a need to provide a power supply for an NFC device that is relatively small, and can maintain operational power over at least several months.

Another problem with NFC devices is the RF interference caused by the required antenna pair. The antenna pair includes a High Frequency Antenna (HFA) which is for RF signals at 2.4 GHz, the other, a Low Frequency Antenna (LFA) is for the NFC RF signal at 13.56 MHz. The LFA is used for NFC read/write, the HFA is used to communicate relative long distance with other application which required a minimum of 30 meters. The long communication RF signal is needed a stable RF signal for calculating the origin of the transmission by the receiving application.

The both HFA and LFA antennas work well by themselves if they are used alone, but when they are compacted into a small space together, they cause signal noise, RF distortion, and weaken the signal strength which will lead to a shortened traveling distance. Another problem is that the metal case of the button battery reflects the RF waves sent by the two antennas. As the results of the metal reflection, the RF signal can become distorted. The last problem was the power consumption of the HFA antenna needed to be small so that it supports the 2-battery year-life.

Accordingly, there is a need to provide an antenna pair for an NFC device that is designed to reduce noise but also have low power consumption.

### BRIEF SUMMARY OF THE INVENTION

The present invention concerns a power supply and antenna arrangement for a portable electronic device. The inventive arrangement uses a large value capacitor in the power supply circuitry to extend the operational life of the battery. Because of the small footprint of the device, multiple smaller capacitors are connected in series to build up the large capacitor value. The antenna arrangement includes HFA and LFA antennas, the antennas are overlaid using insulation material and are geometrically dimensioned and positioned to reduce interference. The insulation material electrically isolates the two antennas, but is RF permeable. In this arrangement, the LFA antenna is generally rectangular whereas the HFA is rendered an arbitrary shape so as to reduce overlap as much as possible. An electromagnetic insulator material between the PCB and the battery case absorbs RF waves to prevent the unwanted reflection of RF waves within the device housing. Software operates to alternate the high and low frequency broadcast to prevent two RF signals from simultaneous broadcast.

It is an object of the invention to provide a power supply for electronic devices.

It is another object of the invention to provide a long lasting power supply for NFC enabled devices.

It is another object of the invention to provide an improved antenna arrangement for NFC enabled devices that reduces signal noise and distortion.

It is another object of the invention to provide an improved antenna arrangement for NFC enabled devices that employs disparately shaped, partially overlapped LFA and HFA antennas.

It is another object of the invention to provide an improved antenna arrangement for NFC enabled devices where the positioning of the LFA and HFA antennas reduces interference.

It is another object of the invention to provide an improved antenna arrangement for NFC enabled devices that uses insulation material to absorb RF energy, preventing signal distorting reflections from metal parts of the housing.

It is another object of the invention to provide an improved antenna arrangement for NFC enabled devices that employs software to prevent two RF signals from simultaneous broadcast.

### BRIEF DESCRIPTION OF THE DRAWINGS

FIG. 1 shows a plan view of the circuit layout of the invention.

FIG. 2 shows a plan view of the circuit topography of the invention.

FIG. 3 shows a plan view illustrating the positioning and arrangement of the LFA antenna of the inventive circuit.

FIG. 4 shows a plan view illustrating the positioning and arrangement of the HFA antenna of the inventive circuit.

FIG. 5 is a plan view illustrating the overlapping of the HFA and LFA antenna.

FIG. 6 is a diagrammatic overview of the overlapping of the antennas and insultation of the inventive circuit.

### DETAILED DESCRIPTION OF THE PREFERRED EMBODIMENTS

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

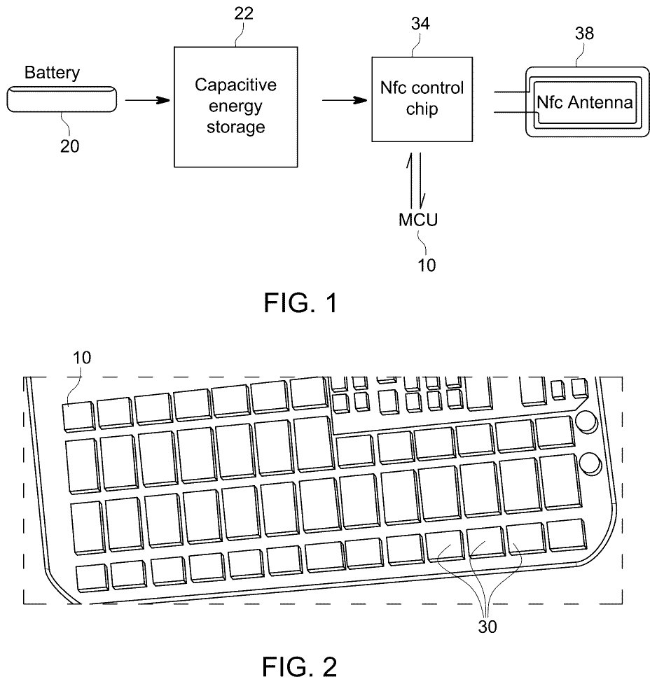

Referring now to FIGS. 1 and 2, the invention is shown. The invention is designed to be implemented on a standard PC board 10, which may be operatively connected to one or more other PC boards as would be apparent to one of skill in the art. The board 10 may be disposed inside of the housing (not shown) of e.g., a medical monitor such as a heart rate monitor, which requires a stable and long term power source. As can be seen in the simplified block diagram of FIG. 1, the primary power source is a battery 20. The battery 20 has to be of a small size to physically fit inside of the small housing of a typical NFC medical monitoring device, so a button type battery is used. A capacitance 22 is positioned in series with the battery 20 to deliver power to the NFC microcontroller, the battery and capacitance forming the power supply for the monitoring device. While the small generally disc shaped button battery provides sufficient power to operate the circuitry, long term operation without charging or battery placement is not possible. Accordingly, the present invention solves the problem by providing a large, energy storing capacitance 22.

A key aspect of the invention is that a single “large” capacitor cannot be used as the capacitance because of power leakage. A large capacitance can be defined as around 500 μF (microfarads). Therefore, an arrangement is required to supply the needed capacitance or energy storage capacity without using a large capacitor. The present invention solves the problem by providing a large capacitance using a series of smaller capacitors connected in series or daisy chained. As can be seen most clearly in FIG. 2, the individual small capacitors 30 can be connected to the board 10 in spaced relation until a desired large capacitance is obtained.

The capacitance 22 is electrically connected to a micro-controller unit 34 which controls transmission and reception of data to and from the monitoring device. An antenna 38 is connected to the micro-controller 34 for receiving and transmitting digital data and control signals.

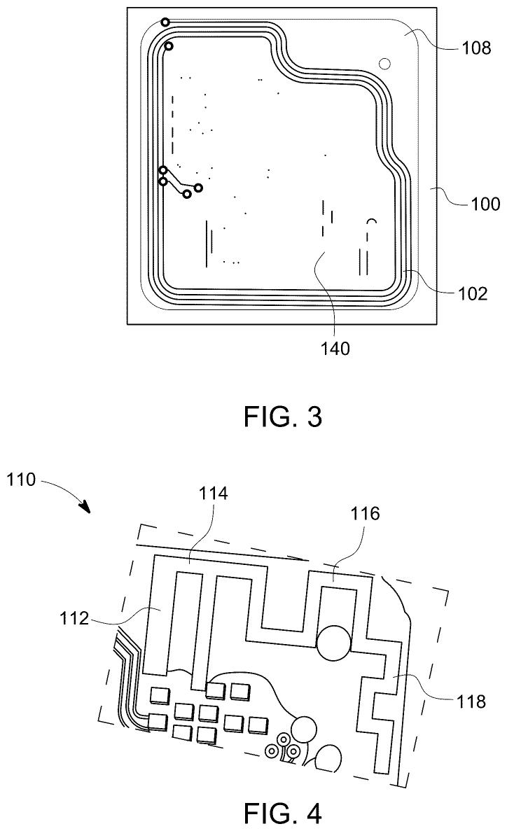

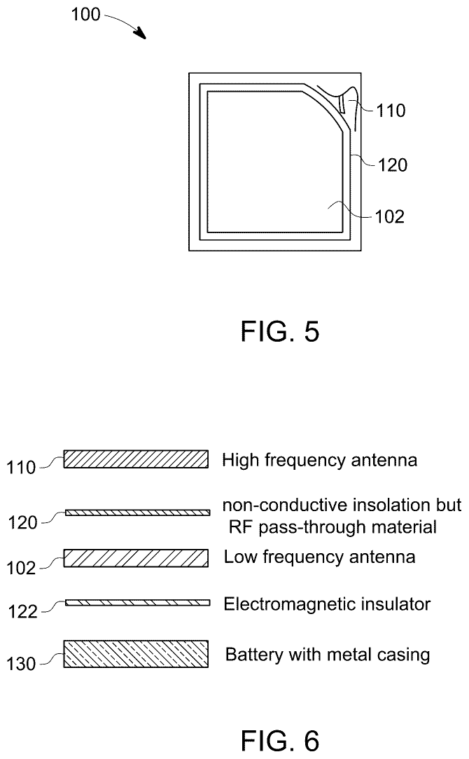

Referring now to FIGS. 3-6 , the antenna layout is illustrated. As mentioned above, an NFC device needs both high (HFA) and low (LFA) frequency antennas. The inventive layout of these antennas is designed to reduce various types of signal degradation that can occur as a result of the layout of the antennas within a relatively small housing, as is typical with NFC devices. In prior art NFC devices, and other small electronic devices with send/receive RF capability, an issue arises because the compact housing forces both LFA and HFA antennas to be in close proximity. Typically, the antennas are formed at the housing perimeter (i.e., on the edges of the PC board contained within the housing). While not typically overlapping, they are generally coextensive, which can create a lot of interference. This problem is exacerbated when both the LFA and HFA antennas are transmitting. The geometry and position of the antennas are modified in the inventive arrangement. Specifically, the LFA antenna 102 is generally coextensive about the circuit board 100 except for a small portion 100 positioned more interiorly as shown in FIG. 3. In accordance with the invention, about 75% of the circuit board perimeter is covered by the LFA antenna, leaving about 25% uncovered. It can be seen that this positioning leaves a corner 108 of the circuit board 100 “open”, that is having no portion of the LFA antenna covering it. The HFA antenna 110 is primarily positioned in the corner 108 as can be seen in FIG. 4, the antenna. Instead of being distributed about the edges of the PC board, the HFA antenna 110 is formed as a series of continuous but irregularly arranged rectangular sections 112, 114, 116, 118 which are layered over the LFA antenna 102 with limited overlap. The disparate shapes of the antennas 102, 110 combined with the “open” corner limit direct overlapping of the antennas. An insulating layer 120 is formed between the HFA 110 and LFA 102 antennas as will be explained in more detail later. This arrangement greatly minimizes the physical overlap of the two antennas 102, 110, which correspondingly greatly reduces the interference.

The vertical arrangement of the various layers of the inventive circuit is illustrated using the diagram of FIG. 6. It can be seen that an NFC device formed in accordance with the invention has two layers of insulation 120, 122. A first layer 120 is positioned between the partially overlain HFA 110 and LFA 102 antennas. The first layer is made of an electrically insulating but RF permeable material. A second layer 122 is positioned between the metallic battery case 130 and the LFA 102 antenna. This layer blocks RF to prevent reflection of signals transmitted from the antennas. The layer 122 is also electrically insulating.

In addition to the physical disposition and arrangement of the antennas 102, 110, signals from the antennas are transmitted alternately under software control via microprocessor 140. Signals from LFA 102 antenna are only transmitted when the HFA antenna 110 is not transmitting and signals from HFA 110 antenna are only transmitted when the LFA antenna 102 is not transmitting so that the two antennas are never transmitting simultaneously. This timing schedule serves to eliminate the interference caused by simultaneous transmission.

The above description and drawings are only to be considered illustrative of exemplary embodiments, which achieve the features and advantages of the present invention. Modification and substitutions to specific process steps, system, and setup can be made without departing from the spirit and scope of the present invention. Accordingly, the invention is not to be considered as being limited by the foregoing description and drawings, but is only limited by the scope of the appended claims.

1. An antenna arrangement for an electronic circuit on a circuit board having a micro-controller unit, a battery compartment, and transmit/receive capability comprising:
a first antenna having a portion generally positioned about a perimeter of the circuit board with a remaining portion positioned interiorly of the perimeter so that one corner of the circuit board is open;
a second antenna positioned generally in said one corner and having a disparate shape compared to said first antenna;
wherein overlap between the first and second antennas is reduced.

2. The antenna arrangement of claim 1 wherein said electronic circuit is an NFC beacon.

3. The antenna arrangement of claim 1 wherein said circuit is for a portable device.

4. The antenna arrangement of claim 3 wherein said portable device is a wearable medical device.
